(19) United States
(12) Patent Application Publication
(10) Pub. No.: US 2015/0052363 A1
(43) Pub. Date: Feb. 19, 2015

(54) SYSTEM AND METHOD FOR PROCESS RESOLUTION AND COMPOSITION IN ACTOR SYSTEMS

(71) Applicants: Fred Korangy, Annapolis, MD (US); Hamed Ghasemzadeh, tehran (IR); Mohsen Arjmandi, Tehran (IR); Reza Azmi, Tehran (IR)

(72) Inventors: Fred Korangy, Annapolis, MD (US); Hamed Ghasemzadeh, tehran (IR); Mohsen Arjmandi, Tehran (IR); Reza Azmi, Tehran (IR)

(73) Assignee: Fred Korangy, Annapolis, MD (US)

(21) Appl. No.: 14/531,116

(22) Filed: Nov. 3, 2014

(51) Int. Cl. G06F 9/52; H04L 9/32

(52) U.S. Cl. CPC G06F 9/52; H04L 9/3247; H04L 9/3263
USPC 713/176; 718/106

(57) ABSTRACT

The various embodiments herein provide an actor oriented system and a method for providing communication between a plurality of processes in the actor system. The system uses actor model as the basis for a large scale process distribution. The system abstracts the plurality of processes and adopts a method of process composition and resolution. The method provides binding of different processes in the system to create a multi-functional distributed application.

### CROSS-REFERENCE TO RELATED APPLICATION

The present application claims the priority of the U.S. Provisional Patent Application with Ser. No. 61/864,677 filed on Aug. 12, 2013, and U.S. Non Provisional patent application with Ser. No. 14/457,141 filed on Aug. 12, 2014 with the title “SYSTEM AND METHOD FOR PROCESS RESOLUTION AND COMPOSITION IN ACTOR SYSTEMS”, and the contents of which are incorporated by reference herein.

### BACKGROUND

1. Technical Field

The embodiments herein generally relate to a composite data processing system and method. The embodiments herein particularly relate to a system and method for distributing applications among a plurality of processes and objects. The embodiments herein more particularly relate to an actor oriented system and a method for providing communication between the plurality of processes and objects in the actor system.

2. Description of the Related Art

Processes and objects of a computer system have dependencies to accomplish their responsibilities towards a computer program. Objects as static software components, acquire these dependencies by referring to other objects and processes. In order to use the object, a user or a system on behalf of the user need to provide dependencies by allowing the process to communicate and by allowing the object to send message to other objects. In present scenario, there are two types of dependency resolution methods to find and connect the process or object dependencies. One of the dependency resolution methods is a static method, which is executed by a compiler or loader of an application and the other is a dynamic method which performed during runtime of the program.

The aforementioned methods involve realizing static description of dependencies without considering that the dependency and the respective vendor may be changed during run time and whereas the system may be developed by different vendors. Further static description of component and process dependencies prevents the system to grow in run time, especially in a large scale distributed application and process composition over actor systems. Another drawback of previous method is that, in the case of process dependencies, the system needs to track common processes and reduce duplicates to start and stop processes. The previous methods lack to provide manual care in such situation.

The aforementioned drawbacks are responsible for creating a system which implements the processes in form of an actor model and provides a method for providing communicate between the processes based on protocols which manage changes in dependencies, manages different vendors providing processes and allows distributed processes to be managed on different platforms.

The above mentioned shortcomings, disadvantages and problems are addressed herein and which will be understood by reading and studying the following specification.

### OBJECTIVES OF THE EMBODIMENTS

The primary object of the embodiments herein is to provide a system and method that adopts an actor oriented concurrency model for providing communication between a plurality of processes in a computer system.

Another object of the embodiments herein is to provide a system and method which manage changes in dependencies, manages different vendors providing processes and allows distributed processes to be managed on different platforms

Yet another object of embodiments herein is to provide a flexible system which incorporates dynamic changes during run time.

Yet another object of embodiments herein is to provide an efficient system which increases the flexibility of a large process composition and allows continuous growth to a core composition.

Yet another object of embodiments herein is to implement a collaborative method between processes which allows large scale installation of actor models and gives the mechanism to create a distribution application based on actor systems.

These and other objects and advantages of the embodiments herein will become readily apparent from the following detailed description taken in conjunction with the accompanying drawings.

### SUMMARY

The various embodiments herein provide an actor oriented system for process distribution. The system comprises: a plurality of processes, and wherein each process is executed by a plurality of actors; a plurality of binding interfaces configured to provide a communication between the plurality of actors; a multi-functional distributed application configured to perform a specific function, wherein the application is processed using the plurality of processes; and a plurality of machines hosting the plurality of processes. The plurality of processes adopts dependencies to accomplish the responsibilities towards the distributed application.

According an embodiment herein, the plurality of binding interfaces adopts a communication protocol. The communication protocol facilitates a routing of non-blocking and asynchronous message between the plurality of processes.

According an embodiment herein, a process comprises at least a sub-process. The sub-process is individually represented by a working actor.

According an embodiment herein, the plurality of processes comprises a plurality of simple processes and a plurality of compound processes. A simple process comprises a single sub-process and a compound process comprises a plurality of sub-processes.

According an embodiment herein, the simple process is transformed into the compound process by adding the plurality of working actors to the simple process. The compound process is created based on a number of machines and resources available in the system.

According an embodiment herein, the plurality of actors of the process is structured in a hierarchical manner, wherein the hierarchy comprises: a parent actor placed on a top level of the actor system; and a plurality of dependent actors reporting to the parent actor. The parent actor is configured to communicate and control the pluralities of dependent actors. The supervision hierarchy is adopted to eliminate a parallel structure for actor systems.

According an embodiment herein, the actor comprises a direct supervisor and a plurality of indirect supervisors to route or pass the messages between the actors.

According an embodiment herein, a naming resolution is provided for each process in the system. The naming resolution adopts a packaging name for identifying the compound process and a subsiding name for each sub-process of the compound process. The name resolution of the actors is performed using a distributed protocol over supervision hierarchy of the actor system.

According an embodiment herein, a dependency list (DL) is maintained for each process. The dependency list (DL) is a list comprising name and version of the process and the dependencies needed by the process.

According an embodiment herein, a plurality of signatures are adopted for representing the plurality of binding interfaces, and wherein the signature for a binding interface comprises: a public key from a process vendor, which is configured to encrypt the signature; a private key adopted to decrypt the encrypted signature and to check the digital signature of the process; an actor reference which is referenced to access service from the actor and to control the actor.

The various embodiments herein provide a method for providing a communication between a plurality of processes and objects in the actor system, wherein the method comprises: transmitting a dependency request to a parent actor; responding back to a request message to all descendant actors of the parent actor; finding a reference for the actor providing a specified dependency; transmitting the URL of the dependent actor to the to the requester, as an actor reference; and adopting a lookup mechanism by the requester, to locate the actor reference.

According an embodiment herein, a sharing method is adopted by the plurality of processes to find replaceable and compatible dependencies. The method comprises: searching the plurality of processes; determining dependencies of the processes; providing binding interfaces to the processes based on their dependencies; filtering the processes based on their compatibility checks; and finding the compatible versions of the processes among currently running processes.

According an embodiment herein, the method adopts the compatible signatures by each actor for finding the dependent processes, wherein the method performing validity check of a given signature comprises: registering the proposing process with the interface part of the signature; creating a digest of the interface; encrypting the given signature with a private key from the created digest; and validating the digital signature of the process by using the public key.

According an embodiment herein, a binding method is adopted for interface binding between the provider and the dependent actors for a given signature, wherein the method comprises: searching the system for the actor realizing the required signature; subscribing the dependency actor with the required signature to the requesting actor, for obtaining the dependency; receiving subscribed messages through the interface binding, by the requesting actor.

According an embodiment herein, the binding method further comprises steps of: detecting the existence of the dependency; introducing the existence of dependency to the parent process, when the dependency is obtained; forwarding an initiation message from the parent actor, to the plurality of dependent actors in the supervision hierarchy; and initiating the binding procedure to start communication between the actors, when the dependent actor receives the message.

According an embodiment herein, the binding method adopts a distributed protocol based on repetitive asynchronous messaging requirements. The protocol recurrently sends asynchronous messages to the dependent actors for introducing the available bindings to the actors and ensures that the messages are ultimately delivered to the dependent actors. The protocol further scales the network when a new node is added to the system.

According an embodiment herein, the binding method creates a plurality of data structures and records within each node. The plurality of data structures and records keeps track on data relating to joining and binding processes of the actors.

According an embodiment herein, the binding method comprises a handshaking phase to choose communication mechanism and protocols for a transportation layer. The handshaking process matches the transportation protocols of the sending and receiving processes.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of an actor oriented system for providing communication between a plurality of processes, according to an embodiment herein.

FIG. 2 illustrates a functional block diagram of the actor system for handling the distributed application, according to an embodiment herein.

FIG. 3 illustrates a flowchart explaining a method for forming a compound process in an actor system, according to an embodiment herein.

FIG. 4 illustrates a flowchart explaining a method for providing communication between a plurality of processes and objects in the actor system, according to an embodiment herein.

FIG. 5 illustrates a flowchart indicating a sharing method adopted by the plurality of processes to find replaceable and compatible dependencies, according to an embodiment herein.

FIG. 6 illustrates a flowchart indicating a binding method adopted for interface binding between the provider and the dependent actors for a given signature, according to an embodiment herein.

Although the specific features of the embodiments herein are shown in some drawings and not in others. This is done for convenience only as each feature may be combined with any or all of the other features in accordance with the embodiments herein.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide an actor oriented system for process distribution. The system comprises: a plurality of processes, and wherein each process is executed by a plurality of actors; a plurality of binding interfaces configured to provide a communication between the plurality of actors; a multi-functional distributed application configured to perform a specific function, wherein the application is processed using the plurality of processes; and a plurality of machines hosting the plurality of processes. The plurality of processes adopts dependencies to accomplish the responsibilities towards the distributed application.

According an embodiment herein, the plurality of binding interfaces adopts a communication protocol. The communication protocol facilitates a routing of non-blocking and asynchronous message between the plurality of processes.

According an embodiment herein, a process comprises at least a sub-process. The sub-process is individually represented by a working actor.

According an embodiment herein, the plurality of processes comprises a plurality of simple processes and a plurality of compound processes. A simple process comprises a single sub-process and a compound process comprises a plurality of sub-processes.

According an embodiment herein, the simple process is transformed into the compound process by adding the plurality of working actors to the simple process. The compound process is created based on a number of machines and resources available in the system.

According an embodiment herein, the plurality of actors of the process is structured in a hierarchical manner, wherein the hierarchy comprises: a parent actor placed on a top level of the actor system; and a plurality of dependent actors reporting to the parent actor. The parent actor is configured to communicate and control the pluralities of dependent actors. The supervision hierarchy is adopted to eliminate a parallel structure for actor systems.

According an embodiment herein, the actor comprises a direct supervisor and a plurality of indirect supervisors to route or pass the messages between the actors.

According an embodiment herein, a naming resolution is provided for each process in the system. The naming resolution adopts a packaging name for identifying the compound process and a subsiding name for each sub-process of the compound process. The name resolution of the actors is performed using a distributed protocol over supervision hierarchy of the actor system.

According an embodiment herein, a dependency list (DL) is maintained for each process. The dependency list (DL) is a list comprising name and version of the process and the dependencies needed by the process.

According an embodiment herein, a plurality of signatures are adopted for representing the plurality of binding interfaces, and wherein the signature for a binding interface comprises: a public key from a process vendor, which is configured to encrypt the signature; a private key adopted to decrypt the encrypted signature and to check the digital signature of the process; an actor reference which is referenced to access service from the actor and to control the actor.

The various embodiments herein provide a method for providing a communication between a plurality of processes and objects in the actor system, wherein the method comprises: transmitting a dependency request to a parent actor; responding back to a request message to all descendant actors of the parent actor; finding a reference for the actor providing a specified dependency; transmitting the URL of the dependent actor to the to the requester, as an actor reference; and adopting a lookup mechanism by the requester, to locate the actor reference.

According an embodiment herein, a sharing method is adopted by the plurality of processes to find replaceable and compatible dependencies. The method comprises: searching the plurality of processes; determining dependencies of the processes; providing binding interfaces to the processes based on their dependencies; filtering the processes based on their compatibility checks; and finding the compatible versions of the processes among currently running processes.

According an embodiment herein, the method adopts the compatible signatures by each actor for finding the dependent processes, wherein the method performing validity check of a given signature comprises: registering the proposing process with the interface part of the signature; creating a digest of the interface; encrypting the given signature with a private key from the created digest; and validating the digital signature of the process by using the public key.

According an embodiment herein, a binding method is adopted for interface binding between the provider and the dependent actors for a given signature, wherein the method comprises: searching the system for the actor realizing the required signature; subscribing the dependency actor with the required signature to the requesting actor, for obtaining the dependency; receiving subscribed messages through the interface binding, by the requesting actor.

According an embodiment herein, the binding method further comprises steps of: detecting the existence of the dependency; introducing the existence of dependency to the parent process, when the dependency is obtained; forwarding an initiation message from the parent actor, to the plurality of dependent actors in the supervision hierarchy; and initiating the binding procedure to start communication between the actors, when the dependent actor receives the message.

According an embodiment herein, the binding method adopts a distributed protocol based on repetitive asynchronous messaging requirements. The protocol recurrently sends asynchronous messages to the dependent actors for introducing the available bindings to the actors and ensures that the messages are ultimately delivered to the dependent actors. The protocol further scales the network when a new node is added to the system.

According an embodiment herein, the binding method creates a plurality of data structures and records within each node. The plurality of data structures and records keeps track on data relating to joining and binding processes of the actors.

According an embodiment herein, the binding method comprises a handshaking phase to choose communication mechanism and protocols for a transportation layer. The handshaking process matches the transportation protocols of the sending and receiving processes.

The various embodiments herein provide an actor oriented system and a method for providing communication between a plurality of processes in the actor system. The system uses actor model as the basis for a large scale process distribution. The system abstracts the plurality of processes and adopts a method of process composition and resolution. The method provides binding of different processes in the system to create a multi-functional distributed application.

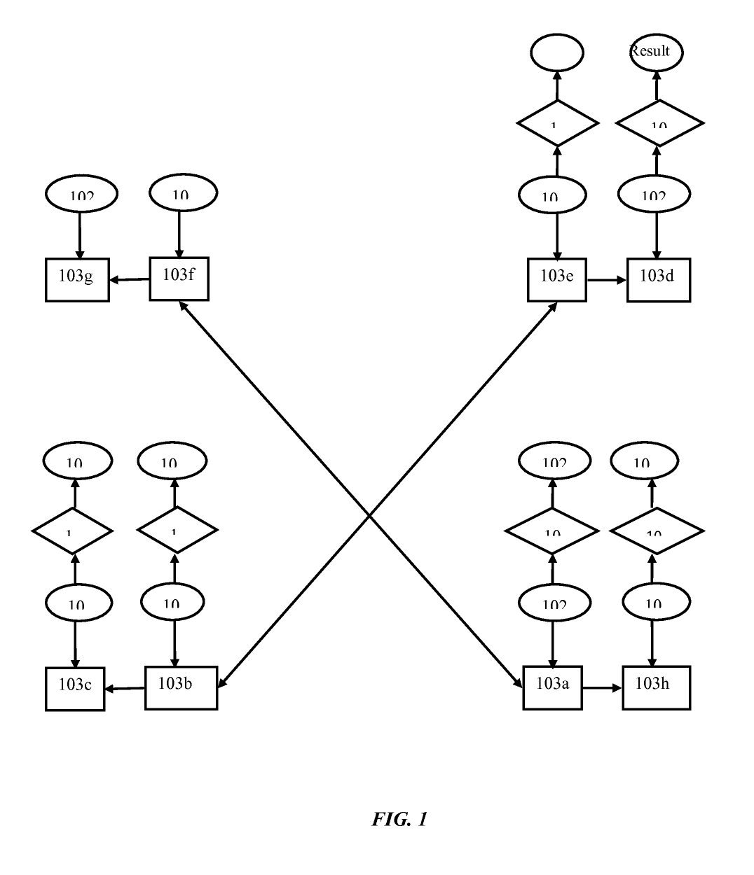

FIG. 1 illustrates an actor oriented system configured for providing communication between a plurality of processes, according to an embodiment herein. With respect to FIG. 1, the system comprises a plurality of processes comprising a plurality of actors 101 and 102; a plurality of binding interfaces configured to provide communication between the plurality of actors, a multi-functional distributed application configured to perform a specific function and a plurality of machines 103 hosting the plurality of processes. The application is processed using the plurality of processes. The plurality of processes adopts dependencies to accomplish the responsibilities towards the distributed application. The plurality of actors 101 and 102 of the process is structured in a hierarchical manner. The supervision hierarchy comprises: a parent actor 101 which is placed on a top level of the actor system; and a plurality of dependent actors 102 reporting to the parent actor 101. The parent actor 101 is configured to communicate and control the pluralities of dependent actors 102. The supervision hierarchy is adopted to eliminate a parallel structure for actor systems.

According an embodiment herein, the actor system comprises a distributed application executed by a plurality of sub-processes, which are located anywhere in a distributed architecture. The purpose is to have a method for dynamic creation of compound actor sets as a composite processing bundle from a set of given working actors so as to construct the actor system gradually and asynchronously at runtime. The system need to share common processes between different applications to reduce process overheads by eliminating duplicated processes at run-time. The processes are executed by a plurality of actors, which are capable of communicating with asynchronous and non-blocking message passing interface realized with a transparent middle-ware such as Akka. The naming and Composition method disclosed herein is an addition to Akka framework.

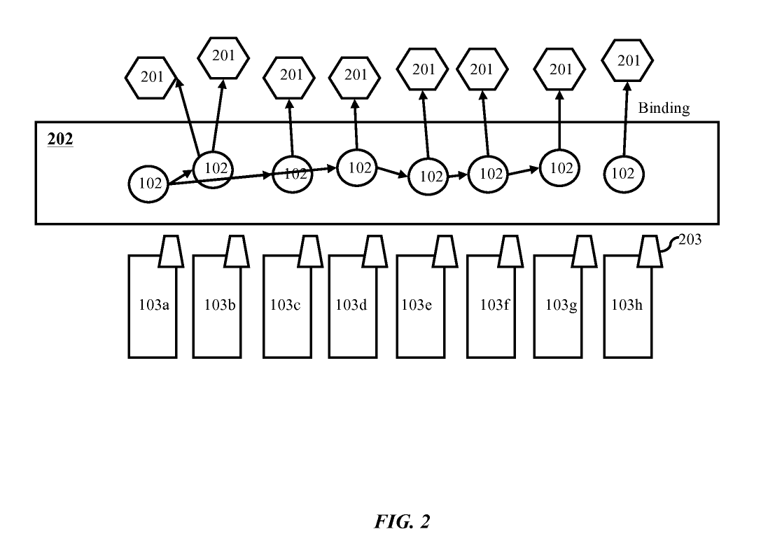

FIG. 2 illustrates a process diagram of the actor system configured for handling the distributed application, according to an embodiment herein. The actor system comprises the set of actors 102 and 201 that are accessed uniformly in a distributed set of machines 103. The actor system adopts a communication protocol for facilitating a non-blocking and asynchronous message passing technique between the plurality of processes 102 and 201. The communication protocol and the message passing technique increase scalability and efficiency of the system therefore enabling the use of modern multi-core architectures. The large scale actor based system addresses different aspects of communication challenges which are faced by a distributed process model. The actor system provides a messaging method, process resolution method and process compositions method. The various methods adopt a plurality of protocols and structures to make different inter-dependent processes work together. The actor system further provides a supervision hierarchy which is effectively used for a lookup procedure. The lookup procedure is used in messaging between the processes and controls their features, enabling the processes to cooperate and change through a period of time.

According an embodiment herein, the actor based system is formed by initiating a plurality of compound processes 202 or simple processes 201 which are placed on top of actor system in reference to the plurality of machines 103. The machines 103 are cooperating through a plurality of cluster binding interfaces 203. The machines 103 register themselves with each other manually. After registration, the machines 103 promote the services and processes provided by them. The processes 102 and 201 in the system are activated by a message and the process dependencies and the plurality of binding interfaces 203 are passed throughout the system. In the second phase, a composition subsystem begins to find and bind dependent interfaces 203 to the required processes. The composition subsystem also keeps a track on the processes that are waiting for a dependency to be available in future. The system further starts the waiting process through a chain of operations, by providing necessary interfaces for the processes to work properly.

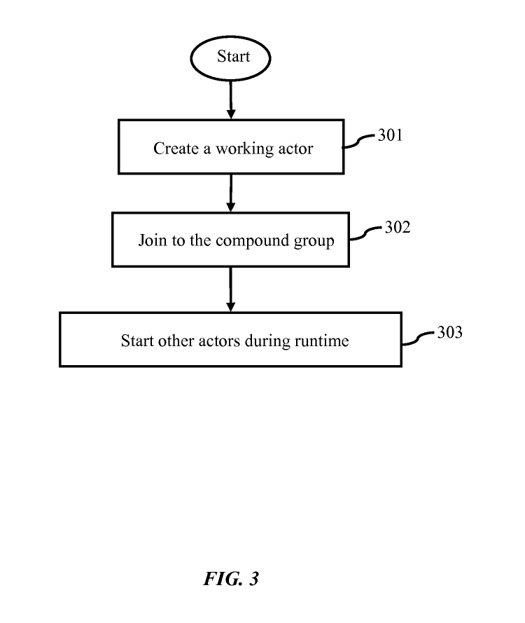

FIG. 3 illustrates a flowchart indicating the steps involved in a method for forming a compound process, according to an embodiment herein. The process may be simple or a compound process consisting of sub-processes. In the system, actors are used as sub-processes and for simple processes there is only one sub-process as working actor. Based on its design, a simple process transforms itself into a compound process. The creation of the compound actor sets from a given actor system is done based on number of machines and resources available in the system. According to FIG. 3, each machine will create a working actor (301) which is to be joined to a group to form the compound process (302). When the compound process comes to existence, it receives a request to start other actors during run time (303). The system is configured to load processes and start dependencies too. When a new process is initiated, a loader of the system initiates a plurality of working actors and adopts a binding procedure to determine input and output of the plurality of working actors. A distribution application is be implemented as operations separated in different stages all performing some activity to messages and data is separated to simple messages passing between process to reach the result of computation.

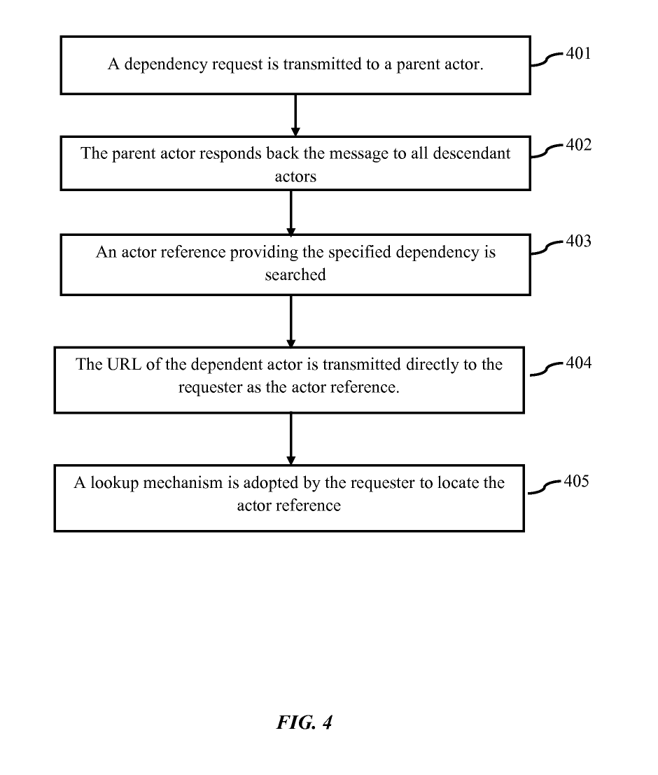

FIG. 4 illustrates a flowchart indicating the steps involved in a method for providing communication between a plurality of processes and objects in the actor system, according to an embodiment herein. According to FIG. 4, the method comprises the following steps. First, a dependency request is transmitted to a parent actor (401). In the second step, the parent actor responds back the message to all descendant actors (402), in-order to find a reference providing the specified dependency (403). When the dependency is found, the URL of the dependent actor is transmitted directly to the requester as an actor reference (404). The method uses requester actor reference in lookup mechanism to send the result directly not through the hierarchy back (Step 405).

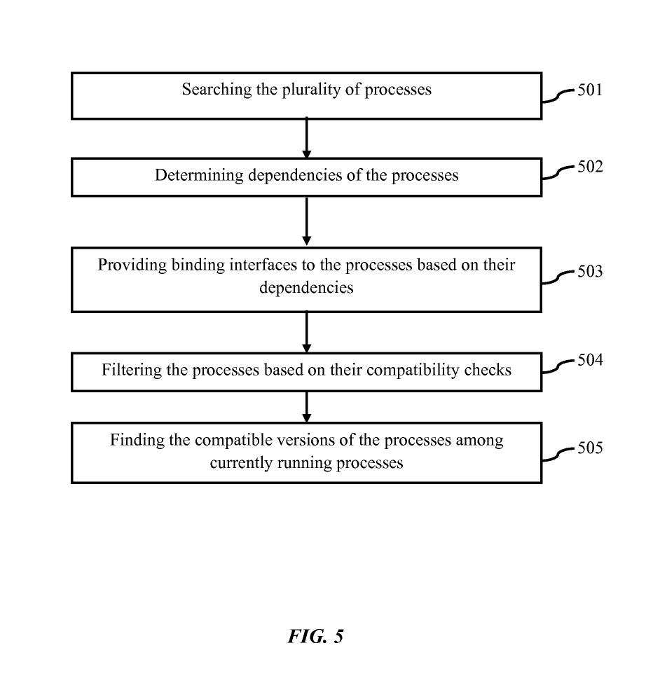

FIG. 5 illustrates a flowchart indicating the steps involved in a sharing method adopted by the plurality of processes to find replaceable and compatible dependencies, according to an embodiment herein. According to FIG. 5, the sharing method comprises the steps of: searching the plurality of processes (501); determining dependencies of the processes (502); providing binding interfaces to the processes based on their dependencies (503); filtering the processes based on their compatibility checks (504); and finding the compatible versions of the processes among currently running processes (505). The method is implemented by coordinating the working actor of a compound process as a parent actor and then sharing the dependencies of the parent actor with all sub-working actors then after. All shared processes maintain a list of all dependent working actors so as to communicate between each other through messages. The list is shared between all sub-workers of a compound process. All the workers send messages to a sub worker of the dependent process adopting Round Robin mechanism. To prevent over load of a single actor in destination, the source will add its ID and then uses a consistent hashing to send to the destination. With this mechanism all dependents and dependences may grow or shrink during runtime giving flexibility to grow the system during run time.

According an embodiment herein, the name for each process is determined by the vendor arbitrarily. The first attempt to figure out the name for a system is by asking the name during run time after the process is created. The loader of the process obtains the name to the process which is introduced to other name resolvers in the system. The system uses package naming for compound processes and uses a name for each sub-process of the compound process. For example, “com.miras.calculator” is the name of “calculator” process. The dependencies are specified by a list that the loader will ask from the process during the pre-start phase. The dependency list (DL) is a list containing all dependencies needed by a process. A record with the DL list specifies name and version of the processes, given that all new versions of a process are compatible with previous version. A filtering mechanism tries to find compatible versions of the process among currently running processes. In the case of multiple compatible processes, the filtering mechanism prefers a newest version of the process than the oldest one. The actors that are sub workers of a given process share the same name as the parent actor. The sub-workers choose an arbitrary id number by generating and examining their existence within their group. Upon request the leader actor introduce themselves as part of the parent process to form a hierarchy. Other system will threat such workers as part of the compound process hierarchically.

According an embodiment herein, the method to share common processes further comprises a technique adopted by each actor used to find a process. The method first tries to find compatible signatures among available and previously started processes. The method sends a request to start a proposed service on the platform, when no running and compatible process is available. The Signatures are basis for binding procedures. The binding procedure seeks a process interface that is a part of the signature which is used to find the process from a vendor. Each instance of a signature has an actor reference as an URL, which is referenced to access service from the actor and to control the actor. The task for binding procedures is to find URL of a given signature and provide an instance URL of actors that provide the required interface specified by the signature. The process signatures are contracting points between different processes to find themselves in runtime. The signature also gives ability to update running processes based on version increments. The method is to stop the updating process and then starting it again to allow other systems to bind to the new version. Further structured lists of processes have listed signatures. The mechanism to allow flexibility in dependency lists is to give ability to specify process signatures by wild card, so as to allow a range of processes, versions or providing vendors. The flexibility increases the chance to find a process and also increases ability of the system to be integrated by different versions of dependencies.

According an embodiment herein, a method is provided to check the validity of a given signature. The method comprises steps of: the proposing process registers the interface part of the signature. The method creates a digest of the interface, which is used to encrypt the given signature with a private key. The private key is provided by the name of the vendor. The method further checks the digital signature of the process by using the public key. The method allows other processes to ensure that the sources of binding processes in runtime increase the security and validity of processes tried upon binding.

According an embodiment herein, the process chooses to depend on specific signature from a key vendor, in-order to solve compatibility issues between different vendors. The system uses a private/public key infrastructure to allow the process to propose the binding interface. By using the special signature for the process, the dependent process communicates with a compatible process without any conflict. The signatures need to have access to security credentials of the vendor. By allowing processes to freely choose the providing vendor of dependencies, they can make sure reducing compatibility issues.

According an embodiment herein, the plurality of actors is classified based on a set of static objects and run-time processes. The static objects are class/module dependencies, whereas the runtime processes are the processes operating over the class objects, which depend on the actor. The actor is a process which defines its dependent processes as actors with a name space, a name and the actual version of the actor. To obtain the required service, a runtime system matches actor names with actor references and provides the interface references to the demanding actor.

According an embodiment herein, the system uses process versioning and process signatures to solve compatibility issues. The system is a protocol implementation and gives an asynchronous interface for message passing according to the protocol definition. The actor depends on a protocol signature, which is a name by convention to separate different protocols and protocol versions. The actor receives a service from the given signature if it matches the required name and has a greater version than the given signature. The processes have ability to update independently and find each other at runtime. Further, the process can request the system to provide dependent processes.

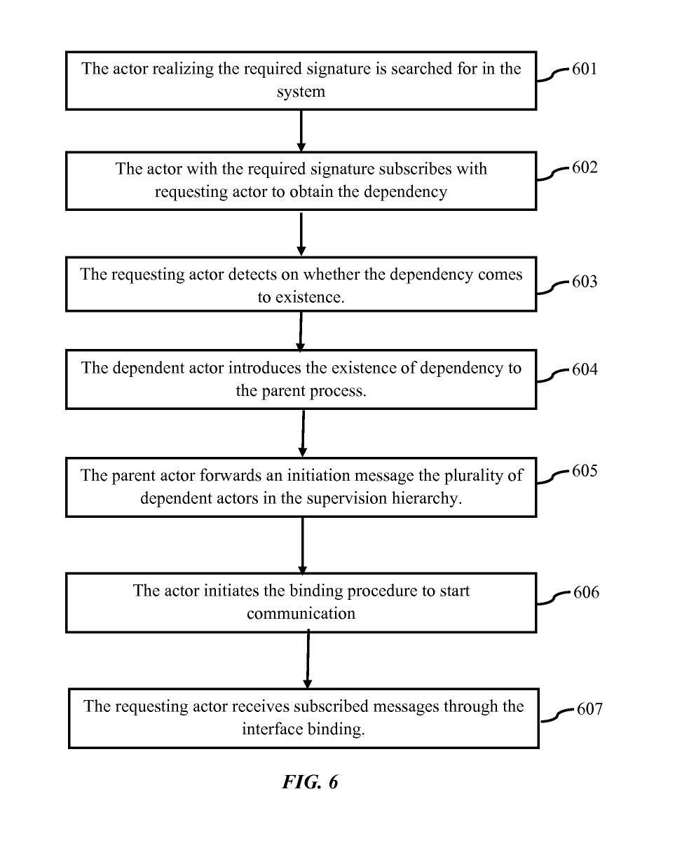

FIG. 6 illustrates a flowchart indicating the steps involved in a binding method is adopted for interface binding between the provider and the dependent actors for a given signature, according to an embodiment herein. According to FIG. 6, the method comprises the following steps. The actor realizing the required signature is searched for in the system (601). The actor with the required signature subscribes with requesting actor to obtain the dependency (602). The requesting actor detects on whether the dependency comes to existence (603). When the dependency is obtained, the dependent actor introduces the existence of dependency to the requesting parent process (604). The parent actor forwards an initiation message the plurality of dependent actors in the supervision hierarchy (605). When the dependent actor receives the message, the actor initiates the binding procedure to start communication (606). After completion of binding procedure, the requesting actor receives subscribed messages through the interface binding (607). The actor negotiates on the protocol and transport mechanism in a handshaking phase. The method have enough descriptive power to create uni-casting and multi-casting subscription queues, perform runtime changes in system topologies, and substitute processes for self-healing purposes.

According an embodiment herein, the binding method adopts a distributed protocol based on repetitive asynchronous messaging. The method recurrently sends asynchronous messages to the dependent actors for introducing the available bindings to the actors. The method ensures the messages are ultimately delivered to the dependent actors. The method further scales the network when a new node is added to the system. The binding procedure is available within each node, which enables the network to grow and scale easily.

According an embodiment herein, the binding method creates a plurality of data structures and records within each node. The plurality of data structures and records keeps track on data relating to joining and binding processes of the actors. The binding method adopts the procedure for registering the dependent actor's reference to dependencies. When the actor finds the reference to the dependency actor, the procedure binds the actor to the interface by adopting the signature of the dependency actor. The binding procedure further tracks life cycle of the binding interface assigned to the dependency actor. The records facilitate the method to restructure the actor system and prevent dangling references. The plurality of processes proposes themselves in a repetitive manner to make sure validity and durability of binding within dependent processes.

According an embodiment herein, the binding method comprises a handshaking phase to choose communication mechanism and protocols for a transportation layer. The purpose of handshaking is to match the transportation protocols of the sending and receiving processes, during the communication. The system uses TCP, by default, but the system runs handshaking, when the process requires UDP or other alternative for transport layer of OSI stack. During handshaking procedure, the process initiates the working actors as sub-processes, based on the required transport protocol. During handshaking, the system stores transport layer request in the interface bindings to make sure communication is performed via an appropriate link. The naming and signature of handshaking protocols are text based so as to make a common understanding possible between remote parties.

According an embodiment herein, the name resolution of the actors is performed using a distributed protocol over supervision hierarchy of the actor system. The actor asks the supervisor first to resolve a new dependency. The process recursively goes through actor hierarchy to map the signature to an actor reference. Upon finding the response, the process goes back through the hierarchy tree. The nodes involved in resolution procedure speeds up the procedure by caching the results for further requests. The actor parents are responsible to provide dependencies for the respective children actors.

According an embodiment herein, the supervision hierarchy is adopted to eliminate a parallel structure for actor systems. Each actor has a direct supervisor and a plurality of indirect supervisors to meet the flow messages between the actors. The actor system further facilitates actor selection to send message through the hierarchy to children. By using the hierarchical structure, the resolution expands over the hierarchy reaching of all nodes in the system. The structure further eliminates parallel structure for resolution and lookup mechanism in the system.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. An actor oriented system for process distribution, comprising:
a plurality of processes, and wherein each process is executed by a plurality of actors;
a plurality of binding interfaces configured to provide a communication between the plurality of actors;
a multi-functional distributed application configured to perform a specific function, wherein the application is processed using the plurality of processes; and
a plurality of machines hosting the plurality of processes;
wherein the plurality of processes adopts dependencies to accomplish the responsibilities towards the distributed application.

2. The system according to claim 1, wherein the plurality of binding interfaces adopt a communication protocol, wherein the communication protocol facilitates a routing of non-blocking and asynchronous message between the plurality of processes.

3. The system according to claim 1, wherein a process comprises at least a sub-process, wherein the sub-process is individually represented by a working actor.

4. The system according to claim 1, wherein the plurality of processes comprises a plurality of simple processes and a plurality of compound processes, and wherein a simple process comprises a single sub-process and a compound process comprises a plurality of sub-processes.

5. The system according to claim 1, wherein the simple process is transformed into the compound process by adding the plurality of working actors to the simple process, and wherein the compound process is created based on a number of machines and resources available in the system.

6. The system according to claim 1, wherein the plurality of actors of the process are structured in a hierarchical manner, wherein the hierarchy comprises:
a parent actor placed on a top level of the actor system; and
a plurality of dependent actors reporting to the parent actor, and wherein the parent actor is configured to communicate and control the pluralities of dependent actors, and wherein the supervision hierarchy is adopted to eliminate a parallel structure for actor systems.

7. The system according to claim 1, wherein the actor comprises a direct supervisor and a plurality of indirect supervisors to route or pass the messages between the actors.

8. The system according to claim 1, wherein a naming resolution is provided for each process in the system, and wherein the naming resolution adopts a packaging name for identifying the compound process and a subsiding name for each sub-process of the compound process, and wherein the name resolution of the actors is performed using a distributed protocol over supervision hierarchy of the actor system.

9. The system according to claim 1, wherein a dependency list (DL) is maintained for each process, and wherein the dependency list (DL) is a list comprising name and version of the process and the dependencies needed by the process.

10. The system according to claim 1, wherein a plurality of signatures are adopted for representing the plurality of binding interfaces, and wherein the signature for a binding interface comprises:
a public key from a process vendor, which is configured to encrypt the signature;
a private key adopted to decrypt the encrypted signature and to check the digital signature of the process;
an actor reference which is referenced to access service from the actor and to control the actor.

11. A method for providing a communication between a plurality of processes and objects in the actor system, wherein the method comprises:
transmitting a dependency request to a parent actor;
responding back to a request message to all descendant actors of the parent actor;
finding a reference for the actor providing a specified dependency;
transmitting the URL of the dependent actor to the to the requester, as an actor reference; and
adopting a lookup mechanism by the requester, to locate the actor reference.

12. The method according to claim 11, wherein a sharing method is adopted by the plurality of processes to find replaceable and compatible dependencies, wherein the method comprises:
searching the plurality of processes;
determining dependencies of the processes;
providing binding interfaces to the processes based on their dependencies; and
filtering the processes based on their compatibility checks; and
finding the compatible versions of the processes among currently running processes.

13. The method according to claim 11, wherein the method adopts the compatible signatures by each actor for finding the dependent processes, wherein the method performing validity check of a given signature comprises:
registering the proposing process with the interface part of the signature;
creating a digest of the interface;
encrypting the given signature with a private key from the created digest; and
validating the digital signature of the process by using the public key.

14. The method according to claim 11, wherein a binding method is adopted for interface binding between the provider and the dependent actors for a given signature, wherein the method comprises:
searching the system for the actor realizing the required signature;
subscribing the dependency actor with the required signature to the requesting actor, for obtaining the dependency;
receiving subscribed messages through the interface binding, by the requesting actor.

15. The method according to claim 14, wherein the binding method further comprises steps of:
detecting the existence of the dependency;
introducing the existence of dependency to the parent process, when the dependency is obtained;
forwarding an initiation message from the parent actor, to the plurality of dependent actors in the supervision hierarchy; and
initiating the binding procedure to start communication between the actors, when the dependent actor receives the message.

16. The method according to claim 14, wherein the binding method adopts a distributed protocol based on repetitive asynchronous messaging requirements, wherein the protocol recurrently sends asynchronous messages to the dependent actors for introducing the available bindings to the actors and ensures that the messages are ultimately delivered to the dependent actors, wherein the protocol further scales the network when a new node is added to the system.

17. The method according to claim 14, wherein the binding method creates a plurality of data structures and records within each node, wherein the plurality of data structures and records keeps track on data relating to joining and binding processes of the actors.

18. The method according to claim 14, wherein the binding method comprises a handshaking phase to choose communication mechanism and protocols for a transportation layer, wherein the handshaking process matches the transportation protocols of the sending and receiving processes.
